(19) United States
(12) Patent Application Publication
(10) Pub. No.: US 2015/0180674 A1
(43) Pub. Date: Jun. 25, 2015

(54) SYSTEM AND METHOD FOR ESTABLISHING AND MANAGING VIDEO AND AUDIO COMMUNICATION SESSIONS USING CONTEXT-BASED INFORMATION IN INTERACTIVE SERVICES

(71) Applicant: VIDYO, INC., Hackensack, NJ (US)

(72) Inventors: Ofer Shapiro, Fair Lawn, NJ (US); Avery More, Dallas, TX (US); Alexandros Eleftheriadis, Tenafly, NJ (US)

(21) Appl. No.: 14/639,772

(22) Filed: Mar. 5, 2015

Related U.S. Application Data
(63) Continuation of application No. PCT/US2013/074993, filed on Dec. 13, 2013.
(60) Provisional application No. 61/736,911, filed on Dec. 13, 2012.

(51) Int. Cl. H04L 12/18; H04L 29/08; G06F 3/0484

(52) U.S. Cl. CPC H04L 12/1822; G06F 3/0484; H04L 67/22

(57) ABSTRACT

Techniques for initiating and managing videoconferences in interactive service applications is described, including using contextual information to identify a group of users that are to participate in an ad-hoc videoconferencing session.

### CROSS REFERENCES TO RELATED APPLICATIONS

This application is a continuation of PCT/US13/074993, filed Dec. 13, 2013, and which claims priority to U.S. Provisional Application No. 61/736,911, filed on Dec. 13, 2012, the disclosures of which are incorporated herein by reference in their entireties.

### SPECIFICATION

1. Field

The disclosed subject matter relates generally to the field of audiovisual communication.

2. Background Information

Instant Messaging (IM) systems have proliferated in recent years. These systems can allow individual users to communicate with other users using text, audio, video, and other types of multimedia data. Examples include free offerings such as Skype and Google Talk, as well as commercial, enterprise systems such as the original Microsoft Office Communication Server and its associated client Microsoft Office Communicator, and its later version called Microsoft Lync.

Certain systems can provide a so-called “presence engine” as well as the ability to communicate via text-based messages. The presence engine can be responsible for registering the status of a user (e.g., available to communicate, idle, unavailable, etc.) and reporting it to other users (such as co-workers, users declared in the system as ‘friends’ of the specific user). A user can typically initiate communication by typing a text message in a window, addressed to another user. The intended recipient of the message can be notified by the software and will be offered the opportunity to reply.

Certain IM systems can offer the ability to conduct text-based conversations among groups of users, i.e., with groups of more than two users at a time. Certain IM systems offer the ability to combine the text-based communication with audio communication whereas others offer the ability to use video as well.

Due to the complexity in offering multi-point video communication, certain systems can allow multi-user audio communication (e.g., Skype or Google Talk) but only person-to-person video communication. There can be technical problems in multi-point video, for example when desktop operation is desired (generally a requirement for an IM system).

Certain multipoint videoconferencing systems can use transcoding or switching Multipoint Control Units (MCUs) to connect participating users with each other. The transcoding MCU can be complex and can add considerable delay, whereas the switching MCU can have limited functionality and flexibility. Another solution for multipoint videoconferencing can use Scalable Video Coding and the so-called Scalable Video Communication Server (SVCS) architecture described in part in commonly assigned U.S. Pat. No. 7,593,032, incorporated herein by reference in its entirety. This solution can allow telepresence-quality multi-point video communication even from regular PC and Mac desktops. It thus can be suitable for use in a desktop-based IM system, as well as systems based on hand-held devices such as iPads and iPhones. Commonly assigned International Patent Application No. PCT/US12/041695, “Systems and methods for improved interactive content sharing in video communication systems,” as well as commonly assigned Provisional U.S. Patent Application Ser. No. 61/699,465, “System and method for agent-based integration of instant messaging and video communication systems,” both incorporated herein by reference in their entirety, describe different mechanisms for integrating IM and videoconferencing systems.

Regardless if audio or video is used, the interactive communication nature of even text-based IM systems can make them an attractive feature of other types of applications, e.g., where Interactive Services (IS) can be deployed as web browser-based applications, such as Gmail or Facebook. In both cases, the user can be provided with the ability to check if one of his or her friends is “online” and initiate a chat session through which the users can exchange text messages in real-time. In these examples the IM functionality can be incorporated as part of the main IS application.

Browser-based applications can use, among other technologies, JavaScript and AJAX (Asynchronous JavaScript and XML) to deliver sophisticated application functionality without requiring the installation of an application native to the operating system used by the host computer. Examples of browser-based IS applications can include shopping applications or sites such as Amazon, trading sites such as E*TRADE, social media sites such as Facebook and Twitter, etc. Certain IM programs themselves can now be implemented simply as web-based applications.

As with IM functionality, the improvement in quality and flexibility of deployment afforded by audiovisual communication systems that use scalable video coding and the SVCS architecture can permit the incorporation of audiovisual communication capabilities in IS applications. These audiovisual communication capabilities can be offered alongside IM capabilities, or by themselves.

When using IM functionality, users can create sessions by selecting the user or users they wish to be connected to. The establishment of an audiovisual communication session can then use the list of the users that participate in a chat in order to identify the users that will participate in the audio or video conference. This is an example of “context” as used in the present application. In this instance, the context in an IM application can be the association of the participating users in an IM group chat. In other types of applications the association can use different attributes. For example, in an online shopping application, the context can be the fact that users are viewing the same item (e.g., a book). In this case the system can offer to initiate an audio or videoconference with other users viewing that same book, or similar books. This capability can be offered alongside, or without IM functionality. It can also be offered just with text-based IM functionality. In other words, the IM session is not initiated manually by the user but by using the current application context.

A further example lies in a device such as the commercially available Amazon Kindle Fire. The system can create ad-hoc groups around a specific book, part of a book, and/or reading interest, which can be used as part of the reading experience and also to increase the involvement of the readers during the reading experience. The IS system can also offer the option to “talk to people who finished this chapter,” through which the user can be connected in an IM chat or videoconferencing session with users who fit that profile and are willing to participate in such ad-hoc meetings. In addition to improving the experience around a book (or any product, for that matter), such capability can lead to an increase in the amount of books purchased by introducing “click to buy” directly into the conferencing context. For example a user can indicate that a book had a particularly effective ending, which reminded him or her of another book that he or she just read. The user can actually introduce a link to that book in the conferencing session so that other users can click on it and purchase it or add it to their lists for later review.

Similar experiences can be created around other types of products being purchased or used, and can also include user-provided support. A user, for example, can indicate how a particular assembly is performed. The creation of topic-specific, or context-specific, user groups that allow people who share the same interest to communicate with each other in an ad-hoc way, without the need to exchange addresses or other information, can create immediately a very powerful social network that can be useful to the end users and not require the migration of user friend lists from other social networks.

It can thus be desirable to design systems and methods that can utilize different types of context in order to create and manage audiovisual communication sessions in IS applications. It can also be desirable to offer one-click integration of products purchased or viewed into a communication session, for example, a videoconferencing session or even a plain text-based IM session.

### SUMMARY

Techniques are disclosed herein for initiating an audio or video conference between an initiating user and one or more selected users in a system. User selection can be performed using context, e.g., a set of attributes characterizing the individual users where the set of attributes can have common or related values.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an exemplary interactive service system;

FIG. 2 is a schematic illustration of an exemplary videoconferencing system;

FIG. 3 is a schematic illustration of an exemplary system combining interactive service and videoconferencing functionality in accordance with the principles of an embodiment of the disclosed subject matter;

FIG. 4 is a schematic illustration of the client system architecture in accordance with the principles of an embodiment of the disclosed subject matter;

FIG. 5 is a flow diagram of the videoconferencing call initiation process; and

FIG. 6 shows an exemplary computer system in accordance with an embodiment of the present disclosure.

The Figures are incorporated and constitute part of this disclosure. Throughout the Figures the same reference numerals and characters, unless otherwise stated, are used to denote like features, elements, components or portions of the illustrated embodiments. Moreover, while the disclosed subject matter will now be described in detail with reference to the Figures, it is done so in connection with the illustrative embodiments.

### DETAILED DESCRIPTION

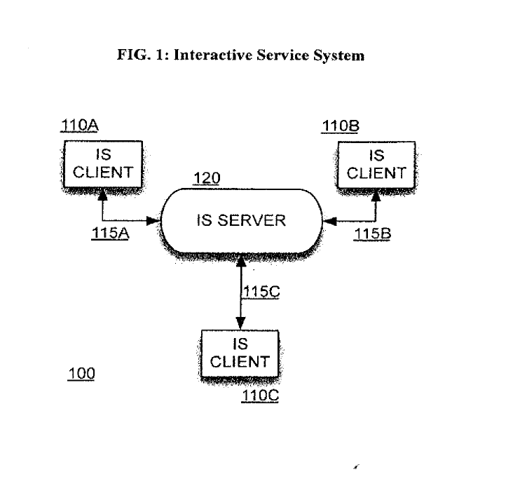

FIG. 1 depicts the architecture of an exemplary IS system 100. In one embodiment of the disclosed subject matter, the IS application can be a service such as the one offered by Amazon.com, where users can order goods, consult product reviews by other users, review product features, review product lists created by other users, get automatically-generated recommendations, etc. The system can include an IS Server 120 and one or more users that employ IS Client systems 110. In the figure, three such clients are shown (110A, 110B, and 110C), but any number of clients can be used. The IS Clients 110 can be connected to the IS Server 120 through a network over connections 115. In an embodiment, a packet-based network using the Internet Protocol (IP) can be used, but other types of networks are also possible.

The IS Client 110 can be standalone software installed and running on a user's desktop or laptop computer or a portable device such as the Apple iPad or the Amazon Kindle. It can also be a web page that is loaded from the IS Server 120 (or another server) onto a user's browser running on any such device. In the latter case, the connections 115 can be within the IS Server 120. Additionally, the IS Client 110 can have a graphical user interface to interact with the user.

In an IS system such as the one shown in FIG. 1, users can employ their IS Client 110 to log in to the IS Server 120 that registers their name. The IS Server 120 can also store user profile information such as billing address, shipping address, product preferences (e.g., clothes' sizes). The profile information can also include preferences regarding communication availability. Availability can be an indication of the user's interest in accepting communication invitations from other users. The user can be given the option to select the type of ‘status’ that he or she wants the system to report, for example, away, not available, do not disturb, invisible, and/or offline.

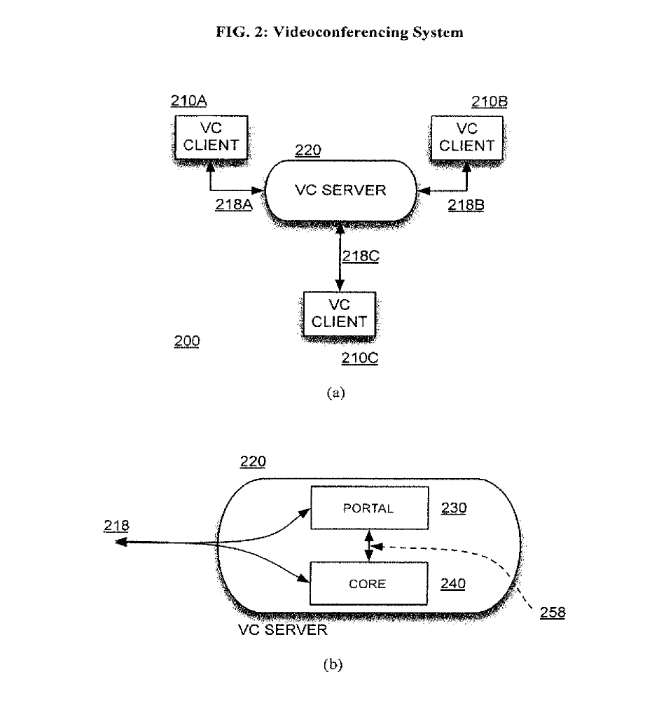

FIG. 2 (a) depicts the architecture of an exemplary videoconferencing system 200. The system can include one or more VC Servers 220 and one or more VC Clients 210. Three such clients are shown in the figure (A, B, and C), with a single VC Server, for purposes of illustration; the disclosed subject matter can be directly used in the case where multiple VC Servers 220 and/or any number of VC Clients 210 are present. The VC Clients 210 and the VC Server 220 can be connected via network connections 218 (A through C). In an embodiment of the disclosed subject matter, the IP protocol can be used for the underlying network. The VC Client 210 can be a standalone system such as a computer-based system with a camera and one or more displays, or it can be software that can be downloaded and run on a user's computer or portable device such as an Apple iPad or Amazon Kindle. Additionally, the VC Client 210 can have a graphical user interface to interact with the user.

FIG. 2 (b) depicts the architecture of an example VC Server 220. The server can include two components, a Portal 230 and a Core 240. In an embodiment, the Portal 230 can perform session management so that users can initiate, receive, or control videoconferencing calls made through the Core 240. The VC Server 220 also can include the Core 240 module, which can be the component that receives, processes, and forwards media. As shown in the figure, the information carried over network connection 218 can be split between the Portal 230 and the Core 240, with media data flowing to/from the Core 240, and user/session management data flowing to/from the Portal 230.

Although FIG. 2 assumes a videoconferencing system, the architecture can be identical for a system offering audio-only conferencing or even just text-based conferencing. Although the following embodiments involve videoconferencing, similar designs can be applicable for audio-only conferencing, text-based conferencing, or conferencing with any media modality.

The Portal 230 and Core 240 can communicate through a connection 258. Although the VC Server is shown as a single unit, the Portal 230 and Core 240 can be hosted on distinct systems that may even be physically in different locations. In that case, for example, the connection 258 can be over the network, rather than being an internal connection within a single system. Additionally or alternatively, one or both of the Portal 230 and Core 240 can be integrated with the IS Server 120 of FIG. 1.

In an embodiment of the disclosed subject matter, the VC Server Core can be a Scalable Video Communication Server (SVCS), as described in part in U.S. Pat. No. 7,593,032, previously cited. Alternative VC Server Core architectures can include the traditional switching Multipoint Control Unit (MCU) or a transcoding MCU.

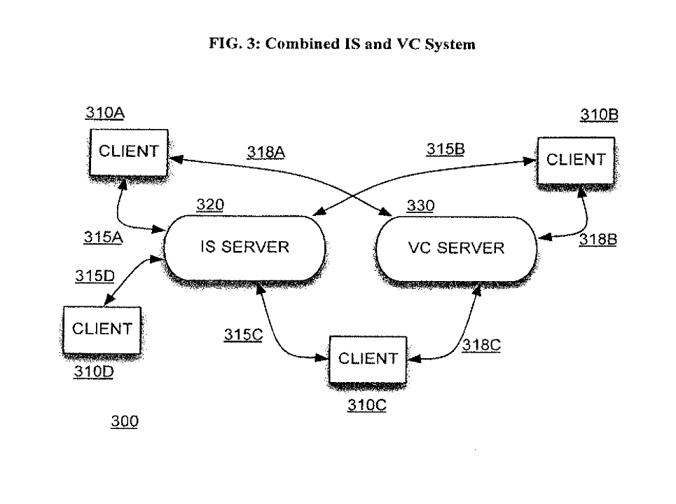

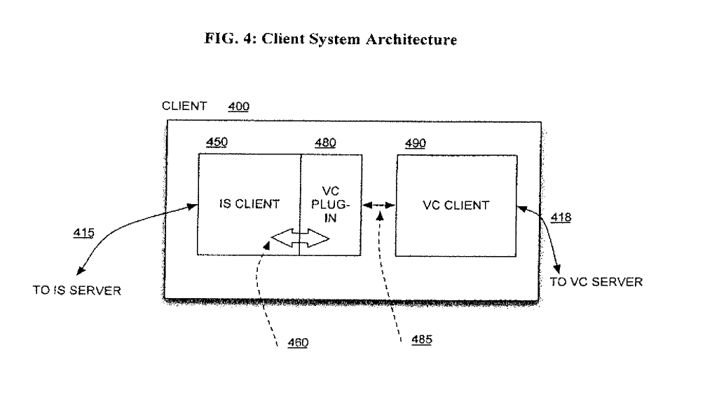

FIG. 3 depicts an exemplary integrated IS and VC system 300 in accordance with an embodiment of the disclosed subject matter. As shown in the figure, the system can have two servers, an IS Server 320 and a VC Server 330. One or more Clients 310, in this example three (A through C), can be connected to both servers using corresponding connections 315 and 318, respectively. Some clients, in this example IM Client 310D, can be connected only to the IS Server 320 using a corresponding connection 315D. The IS Server 320 and VC Server 330 can operate as with the standalone systems shown in FIG. 1 and FIG. 2, respectively. Whereas the servers here can be similar to the servers used in traditional, standalone IS and VC systems, the difference can be in the architecture and operation of the Client 310 and the way sessions are initiated and managed. Additionally, the Clients 310 can operate as with the IS Clients 110 and/or the VC Clients 210, as shown in FIG. 1 and FIG. 2, respectively.

FIG. 4 shows an example Client system architecture in accordance with an embodiment of the disclosed subject matter. The Client 400 can contain an IS client module 450 and a VC client module 490. The IS client module 450 can operate as an IS Client, for example. in the same way as the IS Client(s) shown in FIG. 1. Similarly, the VC client module 490 can operate as a VC Client, for example, in the same way as the VC Client(s) shown in FIG. 2. The Client 400 also can include a VC Plug-in module 480, which can provide videoconferencing system integration, as discussed below. The VC Plug-in module 480 and the IS client module 450 can communicate through the plug-in interface 460. This interface can be defined by, and provided from, the VC system manufacturer. It can allow third-party code, such as the IS Client 450, to integrate with the VC Client 490 and use its functionality. The VC Plug-in module 480 can be integrated into the IS Client module 450 as a single entity by the IS system manufacturer, in which case the distinction between the modules can be functional rather than structural.

The VC Plug-in module 480 can also communicate with the VC Client module 490 through the interface 485. In an embodiment of the disclosed subject matter, the interface 485 can be HTTP-based.

The IS Client module 450 can communicate with the IS server via the connection 415, whereas the VC client module 490 can communicate with the VC Server via the connection 418. The VC Server interface through the connection 418 in an embodiment of the disclosed subject matter can be SOAP-based.

Although the VC Client module 490 is depicted as part of the Client 400, it is noted that this can be only a logical association. Indeed, the VC Client module 490 can be in the same computer system as the IM Client 450 and VC Plug-in 480, or it can be in a different system, possibly even at a different physical location. Indeed, the fact that the VC Client module 490 can communicate with the rest of the system through connections 485 and 418 can make the actual physical location of the VC Client module 490 irrelevant. A benefit of this architecture can be that the VC Client module 490 can be a standalone videoconferencing system such as the commercially available VidyoRoom series of systems. In this case the videoconference can run on a separate computer system than the IM Client 450, but the process of initiating the videoconference from the IS system, as disclosed below, can be similar.

As an example of an IS application scenario, it can be assumed that a user is shopping for a book or already bought a book and has indicated that he or she is willing to participate in ad-hoc conferencing sessions. The IS system can use a number of criteria as context in order to decide which users can be appropriate to be included in an ad-hoc session. Such criteria can include:
shopping for books with similar characteristics
reviewing the same books
are reading the same book
have read the same book
are in the same general place while reading the book.

The last one can be relevant for IS applications that include a book reading component.

Each of these criteria, as well as others, can be used to offer a single-click “talk to relevant users” button that can enable users with common interests to communicate with each other. Additional filtering of the context can be performed by adding qualifications such as:
same age/group
same gender
bought similar things
connected to the user on social media sites
has interacted recently with the user on social media sites
exist in the user's address book.

The design is not limited to IS applications related to books. Other IS applications, not only in e-commerce but other application areas as well, can use the same technique. The criteria can be generalized for different IS applications, where the context can be any characterization of the phase or stage of interaction that the user can be in within the particular system.

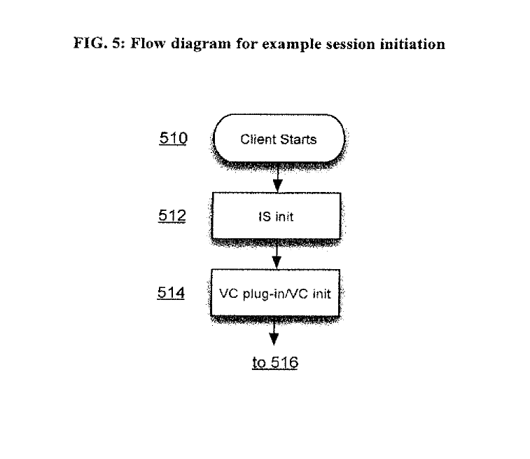

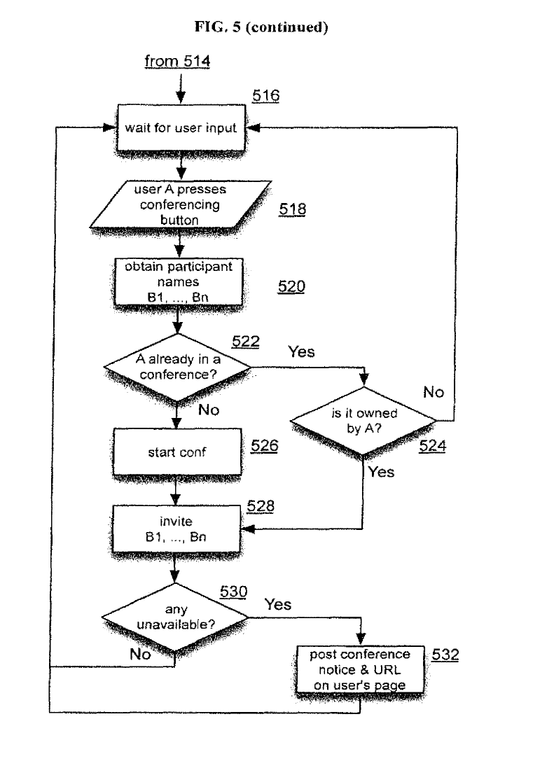

FIG. 5 shows an exemplary flow diagram of the videoconferencing session initiation process. In 510, the Client can be started. Then, in 512, the IS Client can be initialized and the user (e.g., user A) can be asked to login to the IS system. In 514, the VC plug-in and VC module can be initialized. This can be postponed, as discussed below. The system can display a “talk to other users” videoconferencing button that can be persistently displayed in the IS system user interface. The system then can enter an input-waiting mode in 516. During that time, the user can be interacting with the IS system. For example, the user can be navigating the available product catalog, adding or removing things from a shopping cart, etc.

When the user presses the “talk to other users” videoconferencing button in 518, the IS system can request to obtain a list of relevant users B1 through Bn based on the current context. If the initiating user is already in a videoconferencing session, the IS client can invite the users that are not already in the session to the ongoing session in 528. If the initiating user is not already in a videoconferencing session, then a conference session can be first started in 526.

If any of the invited users B1 through Bn is not available, a notice can be posted by the IS application to the user's home page to indicate that a conferencing session is ongoing, and it can also include a link that, when accessed, can take the user in the videoconferencing session. The system then can return to the input waiting state of 516.

There are, of course, obvious variations to the process described above. For example, instead of obtaining the list of names in 520 on the IS Client the list can be generated and used directly at the IS Server alter a request is made by the IS Client. In addition, the initialization of the VC plug-in and/or the VC Client can be performed at different times. For example, they can be initialized after user A has pressed the videoconferencing button, between the 518 and 520.

After the videoconferencing session has been initiated, the participating users can continue using the IS Client and can interact with the IS system. The association that can be created by the fact that users are within the same videoconferencing session can now be used by the IS service to facilitate further content sharing. For example, any of the users can refer to another product on the IS catalog. That user can navigate to it, and then can click on a button so that that the product can be entered into special lists in all participating users (similar to “wish list” offered by some systems, there can be a “session list”). A link to the product also can be inserted in the common chat window, if one is available in the particular communication modality.

The IS service can offer a volume discount if all participating users purchase a particular item. That can help in business models such as the one offered by Groupon, where a discount offer can be executed only if a minimum number of users participate.

In general, the association can be used for any content sharing between the participating users. This can be used by the IS system as means of establishing social network connections between users that would otherwise not interact with each other.

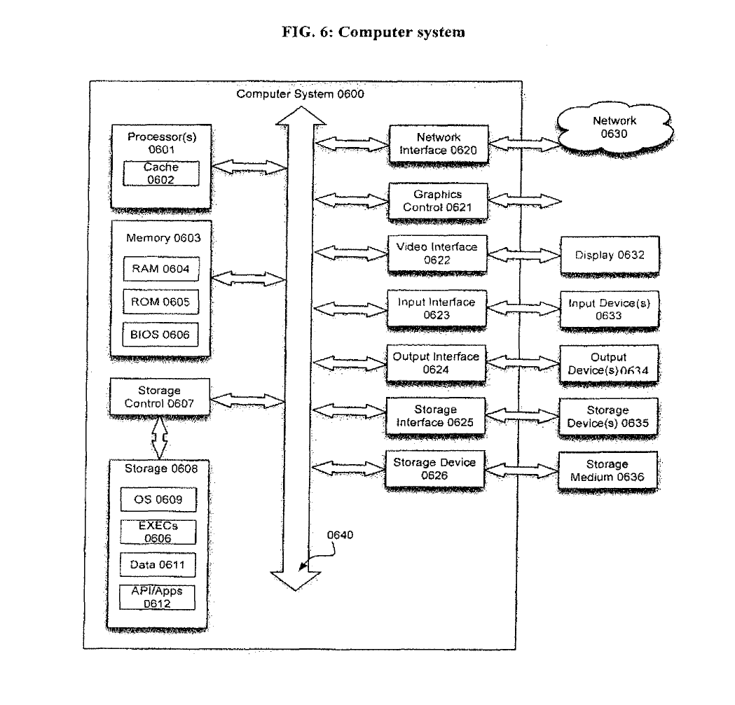

The methods for initiating and managing videoconferences described herein can be implemented as computer software using computer-readable instructions and physically stored in computer-readable medium. The computer software can be encoded using any suitable computer languages. The software instructions can be executed on various types of computers. For example, FIG. 6 illustrates a computer system 600 suitable for implementing embodiments of the disclosed subject matter.

The components shown in FIG. 6 for computer system 600 are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system. Computer system 600 can have many physical forms including an integrated circuit, a printed circuit board, a small handheld device (such as a mobile telephone or PDA), a personal computer or a super computer.

Computer system 600 can include a display 632, one or more input devices 633 (e.g., keypad, keyboard, mouse, stylus, etc.), one or more output devices 634 (e.g., speaker), one or more storage devices 635, and various types of storage medium 636.

The system bus 640 can link a wide variety of subsystems. As understood by those skilled in the art, a “bus” refers to a plurality of digital signal lines serving a common function. The system bus 640 can be any of several types of bus structures including a memory bus, a peripheral bus, and a local bus using any of a variety of bus architectures. By way of example and not limitation, such architectures can include the Industry Standard Architecture (ISA) bus, Enhanced ISA (EISA) bus, the Micro Channel Architecture (MCA) bus, the Video Electronics Standards Association local (VLB) bus, the Peripheral Component Interconnect (PCI) bus, the PCI-Express bus (PCI-X), and the Accelerated Graphics Port (AGP) bus.

Processor(s) 601 (also referred to as central processing units, or CPUs) optionally can contain a cache memory unit 602 for temporary local storage of instructions, data, or computer addresses. Processor(s) 601 can be coupled to storage devices including memory 603. Memory 603 can include random access memory (RAM) 604 and read-only memory (ROM) 605. As is well known in the art, ROM 605 can act to transfer data and instructions uni-directionally to the processor(s) 601, and RAM 604 can be used typically to transfer data and instructions in a bi-directional manner. Both of these types of memories can include any suitable of the computer-readable media described below.

A fixed storage 608 also can be coupled bi-directionally to the processor(s) 601, optionally via a storage control unit 607. It can provide additional data storage capacity and can also include any of the computer-readable media described below. Storage 608 can be used to store operating system 609, EXECs 610, application programs 612, data 611 and the like and can be typically a secondary storage medium (such as a hard disk) that can be slower than primary storage. It should be appreciated that the information retained within storage 608, can, in appropriate cases, be incorporated in standard fashion as virtual memory in memory 603.

Processor(s) 601 also can be coupled to a variety of interfaces such as graphics control 621, video interface 622, input interface 623, output interface 624, storage interface 625, and these interfaces in turn can be coupled to the appropriate devices. In general, an input/output device can be any of: video displays, track balls, mice, keyboards, microphones, touch-sensitive displays, transducer card readers, magnetic or paper tape readers, tablets, styluses, voice or handwriting recognizers, biometrics readers, or other computers. Processor(s) 601 can be coupled to another computer or telecommunications network 630 using network interface 620. With such a network interface 620, it can be contemplated that the CPU 601 can receive information from the network 630, or can output information to the network in the course of performing the above-described method. Furthermore, method embodiments of the present disclosure can execute solely upon CPU 601 or can execute over a network 630 such as the Internet in conjunction with a remote CPU 601 that can share a portion of the processing.

According to various embodiments, when in a network environment, e.g., when computer system 600 is connected to network 630, computer system 600 can communicate with other devices that are also connected to network 630. Communications can be sent to and from computer system 600 via network interface 620. For example, incoming communications, such as a request or a response from another device, in the form of one or more packets, can be received from network 630 at network interface 620 and stored in selected sections in memory 603 for processing. Outgoing communications, such as a request or a response to another device, again in the form of one or more packets, can also be stored in selected sections in memory 603 and sent out to network 630 at network interface 620. Processor(s) 601 can access these communication packets stored in memory 603 for processing.

In addition, embodiments of the present disclosure further relate to computer storage products with a computer-readable medium that have computer code thereon for performing various computer-implemented operations. The media and computer code can be those specially designed and constructed for the purposes of the present disclosure, or they can be of the kind well known and available to those having skill in the computer software arts. Examples of computer-readable media can include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as application-specific integrated circuits (ASICs), programmable logic devices (PLDs) and ROM and RAM devices. Examples of computer code can include machine code, such as produced by a compiler, and files containing higher-level code that are executed by a computer using an interpreter. Those skilled in the art should also understand that term “computer readable media” as used in connection with the presently disclosed subject matter does not encompass transmission media, carrier waves, or other transitory signals.

As an example and not by way of limitation, the computer system having architecture 600 can provide functionality as a result of processor(s) 601 executing software embodied in one or more tangible, computer-readable media, such as memory 603. The software implementing various embodiments of the present disclosure can be stored in memory 603 and executed by processor(s) 601. A computer-readable medium can include one or more memory devices, according to particular needs. Memory 603 can read the software from one or more other computer-readable media, such as mass storage device(s) 635 or from one or more other sources via communication interface. The software can cause processor(s) 601 to execute particular processes or particular parts of particular processes described herein, including defining data structures stored in memory 603 and modifying such data structures according to the processes defined by the software. In addition or as an alternative, the computer system can provide functionality as a result of logic hardwired or otherwise embodied in a circuit, which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method of initiating a conference between an initiating user and one or more users of an interactive service system, the method comprising:
receiving a request from the initiating user that a conference be created between the initiating user and the one or more users;
using context information to select the one or more users;
determining whether the initiating user is in a conference that the initiating user is allowed to manage, and if not, starting a new conference;
requesting that the selected one or more users be added to the conference.

2. The method of claim 1, wherein the request from the initiating user is received through a graphical user interface.

3. The method of claim 1, wherein any of the one or more users unavailable to be added to the conference is notified of the conference by the interactive service system.

4. The method of claim 3, wherein the notification by the interactive service system includes information that allows the notified user to join the conference.

5. The method of claim 1, wherein the context information used to select the one or more users includes a phase the user is in in the interaction with the interactive service system.

6. The method of claim 1, wherein the context information used to select the one or more users includes one or more of the following criteria:
shopping for products with similar characteristics
reviewing the same product
have purchased, viewed, or heard, the same product
for book products, are reading the same book
for book products, are in, or near, the same page in the book
age group
gender
similar purchasing choices to the initiating user
connected to the initiating user in services offering user connection properties.

7. The method of claim 1, further comprising sending information from an originating user to all of the one or more users added to the conference.

8. A computer system for initiating videoconferencing sessions from instant messaging sessions, comprising:
(a) a processor; and
(b) a computer readable medium embodying software that is configured when executed by one or more of the processors to perform the method of claim 1.

9. A computer system for initiating videoconferencing sessions from instant messaging sessions, comprising:
(a) a processor; and
(b) a computer readable medium embodying software that is configured when executed by one or more of the processors to perform the method of claim 2.

10. A computer system for initiating videoconferencing sessions from instant messaging sessions, comprising:
(a) a processor; and
(b) a computer readable medium embodying software that is configured when executed by one or more of the processors to perform the method of claim 3.

11. A computer system for initiating videoconferencing sessions from instant messaging sessions, comprising:
(a) a processor; and
(b) a computer readable medium embodying software that is configured when executed by one or more of the processors to perform the method of claim 4.

12. A computer system for initiating videoconferencing sessions from instant messaging sessions, comprising:
(a) a processor; and
(b) a computer readable medium embodying software that is configured when executed by one or more of the processors to perform the method of claim 5.

13. A computer system for initiating videoconferencing sessions from instant messaging sessions, comprising:
(a) a processor; and
(b) a computer readable medium embodying software that is configured when executed by one or more of the processors to perform the method of claim 6.

14. A computer system for initiating videoconferencing sessions from instant messaging sessions, comprising:
(a) a processor; and
(b) a computer readable medium embodying software that is configured when executed by one or more of the processors to perform the method of claim 7.

15. A computer system for initiating videoconferencing sessions from instant messaging sessions, comprising:
(a) a processor; and
(b) a computer readable medium embodying software that is configured when executed by one or more of the processors to perform the method of claim 8.
